(19) United States
(12) Patent Application Publication
(10) Pub. No.: US 2022/0197963 A1
(43) Pub. Date: Jun. 23, 2022

(54) System and Method for Matching Consumers with Fashion Influencers Based on Individual Body Measurements

(71) Applicant: Kince Inc., New Orleans, LA (US)

(72) Inventor: Jessica KINCL, New Orleans, LA (US)

(21) Appl. No.: 17/163,958

(22) Filed: Feb. 1, 2021

Related U.S. Application Data
(60) Provisional application No. 63/127,270, filed on Dec. 18, 2020.

(51) Int. Cl. G06F 16/9535; G06Q 30/06

(52) U.S. Cl. CPC G06F 16/9535; G06Q 50/01; G06Q 30/0627; G06Q 30/0643

(57) ABSTRACT

The disclosed principles provide for a platform and related service that personalizes a fashion consumer's experience of shopping by matching fashion/clothing influencers with fashion/clothing consumers based on each individual's size or body measurements. By connecting such fashion consumers with fashion influencers who have the same or similar body size measurements, consumers that are users of a system or method in accordance with the disclosed principles are able to use influencers as their “virtual self” when shopping for fashion online. The disclosed principles thus leverage a real time database of body measured matches to provide a consumer with a global pool of influencers based on matched body size or measurements, then allow the user to filter their results based on location, style, fashion item and/or and personal preferences.

### RELATED APPLICATIONS

The present disclosure claims priority to U.S. Provisional Patent Application Ser. No. 63/127,270, filed Dec. 18, 2020, the entirety of which is incorporated herein by reference for all purposes.

### TECHNICAL FIELD

The present disclosure relates in general to the field of social network-based systems and processes, and more particularly to a platform and related service or process for matching fashion influencers to consumers based on matching a consumer's specific body measurements with the specific body measurements of influencers.

### BACKGROUND

E-Commerce Automation Tools that aim to offer a more consumer personalized experience such as fit technology, virtual fitting rooms, influencers and virtual shopping assistants are helping to grow the Fashion E-Commerce Industry at a compound annual rate of 10.6%, making the global fashion e-commerce industry the highest growing e-commerce industry. However, the current method of entry into Fashion E-Commerce forces consumers into channels (e.g., brand/retail websites, social media platforms or other fashion apps) before consumers shop for fashion, and the E-Commerce Tools that help to personalize a consumer's experience are channel specific. As a result, the Fashion E-Commerce Industry is experiencing a crisis of high return rates, with 30%-50% of all fashion purchased, returned. Limited personalization tools mean poor purchase decisions and billions of dollars of lost revenue.

Based on a Shopify survey of over 1,000 businesses and over 800,000 customers, the biggest driver for all fashion e-commerce returns are preference-based, with the number one stated reason for returns as poor clothing fit (52%.) Based on a survey of over 3,000 fashion consumers by Narvar, a retail technology provider, “clothing size and fit is the most common reason to return an online order,” as 46% of items were returned due to fit. According to Happy Returns, an online company that partners with retailers to streamline the return process, around 40% of total returns come from apparel as consumers “order multiple sizes or colors to try on at home.” Happy Returns goes on to say, “while there are 3D body scanning and other fit innovations, it's not working.” Consequently, both retailers and shoppers are losing. Retailers want to provide products, and shoppers want to buy products that fit. In a study of sizing tables for over twenty brands, not a single brand had the same measurements for what constitutes a particular size. These consumer surveys and return statistics suggest fashion consumers are not actually receiving a relevant, personalized shopping experience and as such, consumers do not trust their fashion e-commerce experience enough to keep the fashion they purchase.

In an attempt to solve fashion fit issues, retailers and shoppers are turning to “influencers,” and particularly influencers on social media. Social media influencers are persons who have built a reputation for their knowledge and expertise on a specific topic. One area of extreme interest for social media influencers is the global fashion industry. In 2019, there were 500,000 influencers on social media, supported by the 8 out of 10 consumers who purchased an item recommended by an influencer. When looking at the global spending on influencers, 93% of marketers currently use influencers for advertising, and 57% of marketers plan to increase influencer marketing budgets in 2020. The symbiotic relationships between influencer and consumer, and influencer and marketer, not only show an overall acceptance of influencers' role in e-commerce, but they also pave the road to a projected $15 billion influencer marketing industry by 2022, making influencer marketing the fastest-growing method of customer acquisition (2018 amounted to $4.7B and 2019 hit $8B.)

Influencers provide fashion brands/retailers access to target market groups with measurable results. Business Insider suggests “influencers become increasingly vital intermediaries, helping to connect brands with consumers in highly resonant, authentic ways that can deliver immediate returns.” In a survey of 500 consumers published by Influencer Intelligence, the top reasons consumers look to influencers are for “brand discovery, style inspiration and for help researching or finalizing a purchase decision.” Furthermore, influencers vary in size and shape like consumers, which enables those consumers to turn to social media influencers to see how the clothing fits on a “real” person.

The rise of influencers through both the global spending on influencers and consumer insights suggest influencers are a key tool in shaping the future of fashion e-commerce. However, consumers are still tasked with finding influencers whose body size and style aligns with their own to get a fully personalized fashion e-commerce experience. Accordingly, what is needed in the art is a platform that methodizes the search to match fashion e-commerce consumers with fashion influencers based on similar attributes, specifically body size measurements, location and personal preferences to address the top stated preference-based reasons for fashion returns and, more specifically, the number one stated reason for fashion returns, “poor clothing fit,” to reduce the probability of returns. The disclosed principles provide such a platform.

### SUMMARY

In order to overcome the deficiencies of the prior art, the disclosed principles provide for a platform and related service that personalizes a fashion consumer's experience of shopping by matching fashion/clothing influencers with fashion/clothing consumers based on each individual's size or body measurements. As used herein, the term “influencer” means brand models, hired personnel, affiliates, or any person whose job is to present and thereby advertise for a fashion brand, retailer or manufacturer. Thus, the term influencer is not intended to be limited to a particular occupation, but instead is intended to be broad enough to encompass any person who is, whether paid to do so or voluntarily, trying to influence others about fashion. By connecting such fashion consumers with fashion influencers who have the same or similar body size measurements, consumers that are users of a system or method in accordance with the disclosed principles are able to use influencers as their “virtual self” when shopping for fashion online. The terms “consumer” and “user” are used interchangeably herein to indicate a person that is a both a fashion consumer and a user of a system or method in accordance with the disclosed principles. Also as used herein, the term “fashion” is intended to include apparel, footwear, headwear, accessories, and any other item that may be worn or otherwise adorned by a person. Through the disclosed social platform, fashion consumers can match and connect with fashion influencers around the world who share their same body size and shape, as well as those matching a desired style. The disclosed principles leverage a real time database of body measured matches to provide a consumer with a global pool of influencers based on matched body size or measurements, then allow the user to filter their results based on location, style, fashion item and/or personal preferences.

### BRIEF DESCRIPTION OF THE DRAWINGS

For a more complete understanding of the present invention and its advantages, reference is now made to the following description and the accompanying drawings, in which:

FIG. 1 illustrates a collection of screenshots of a mobile telephone executing an application in accordance with the disclosed principles;

FIG. 2 illustrates a screenshot on a mobile telephone executing one embodiment of a software application in accordance with the disclosed principles and prompting a user to enter specific measurements of their body, or alternatively of a body the user will be trying to match;

FIG. 3 illustrates a screenshot on a mobile telephone executing one embodiment of a software application in accordance with the disclosed principles, and providing information to the user on how to take the specific measurement(s) of their body measurement the application has prompted them for;

FIG. 4 illustrates a screenshot of a mobile telephone executing one embodiment of a software application in accordance with the disclosed principles, and providing a Home Platform screen to a user;

FIG. 5 illustrates a screen shot of an exemplary Newsfeed of influencers;

FIG. 6 illustrates a screen shot of an exemplary Influencer Profile in accordance with an embodiment of the disclosed principles;

FIG. 7 illustrates an exemplary embodiment of a code for use in searching for matching influencers that may be generated by a platform or service in accordance with the disclosed principles;

FIG. 8 illustrates a screen shot of an additional embodiment of a Newsfeed that provides advertisement capability for brands/retailers;

FIG. 9 illustrates a screen shot of one embodiment of a virtual office setting background having size-matched influencers of a searching user; and

FIG. 10 illustrates one embodiment of an exemplary platform or system constructed and implemented in accordance with the disclosed principles.

### DETAILED DESCRIPTION

The following detailed description includes exemplary embodiments of the invention disclosed and reference is made to the accompanying figures that form a part hereof. The figures here are shown to illustrate specific embodiments in which the invention may be practiced. Please understand that other embodiments will be utilized which may include structural changes and modifications made without departing from the scope of the present invention.

The disclosed principles provide a platform and related service that is unique as compared to current conventional approaches and technology. The disclosed principles provide a consumer with a global pool of influencers based on body size/measurements, and then allow them to filter based on location, style and personal preferences. There are many social media platforms and e-commerce apps that allow users to follow influencers such as Instagram and Liketoknowit, but there is no platform that facilitates the initial connection between consumer/shopper and influencer based on like characteristics, and in particular body size/measurements.

Currently, brands/manufacturers are addressing clothing fit issues by encouraging customer reviews with pictures, providing size tables per brand, posting videos of the flow of the clothing, providing the height, weight and size of the model pictured, and using integrated fitting tools. However, research reveals that shoppers desperately want better sizing options, and only a small percentage of consumers (14%) actually find online size charts helpful.

There has also been a large push for more realistic approaches, and apps have surfaced that offer 3D body scans of the consumer to suggest clothing sizes per brand, and AI technology that builds a model based on user measurements. While these options are more individually focused on the consumer, low user downloads and negative reviews of inconsistencies are a primary concern. The low adoption rate of these technologies suggests that consumers are not necessarily wanting to see their individual bodies in clothes, but rather, are wanting to see a lifestyle that their body can be a part of Without the influencer culture in these conventional approaches, consumers are missing the social media cultural component that drives the purchase.

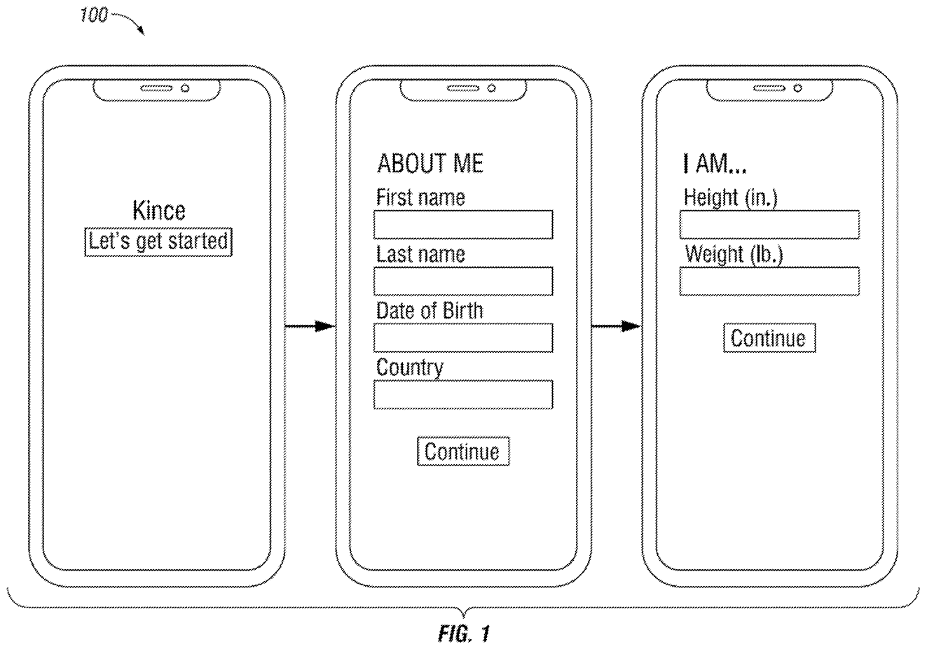

Looking first at FIG. 1, illustrated is a collection of screenshots 100 of a mobile telephone executing an application in accordance with the disclosed principles. In particular, these screenshots are exemplary screens that a new user of the app may be presented. Users will flip through each of the screens in the app, entering their basic information as requested on each screen. For example, as the user clicks or sweeps in introduction screen, the next screen may be used to gather the user's personal identification information, such as name, age and location.

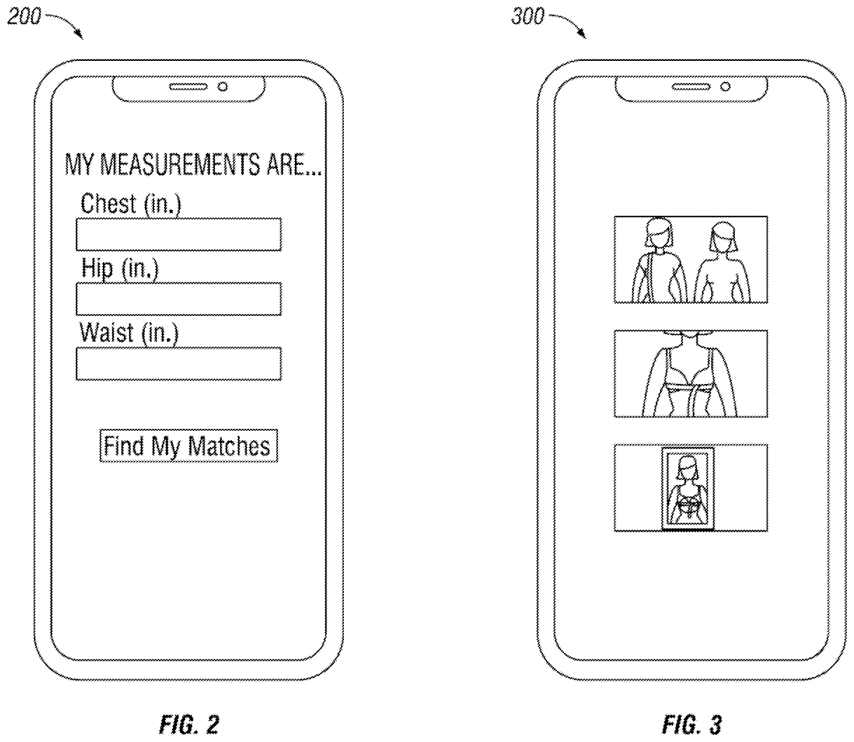

Once the user's personal and contact information is gathered and saved by the application software, the user is then prompted to begin entering personal information specific to their particular body. For example, as illustrated, the application may first ask the user to enter their height and weight information. Moving on to FIG. 2, illustrated is a screenshot 200 on a mobile telephone executing one embodiment of a software application in accordance with the disclosed principles, and prompting a user to enter specific measurements of their body, or alternatively of a body the user will be trying to match. In the illustrated example, the specific measurements requested by the application are measurements of the user's chest, hips, and waist. The application may be configured to record these various measurements in any of a number of units of measurement, such as inches or centimeters.

Moreover, although in the illustrated embodiment only three measurements are prompted for the user's entry, other embodiments of a platform or service implemented in accordance with the disclosed principles will prompt a user for even further measurements. For example, one embodiment may additionally prompt a user for one or more other body measurements like biceps size, thigh size, calf size, shoe size, neck size, hat size, shoulder size, torso length, inseam length, outer seam length, and/or sleeve length. Of course, other measurements, such as simply a conventional dress size, may also be requested of the user without departing from the spirit and scope of the disclosed principles. By providing such specific measurements, as opposed to simply a clothing size, the height, weight, and even gender of the persons whose measurements are being collected for searching with the platform/service become relatively irrelevant. Instead, the search for influencers is done by matching one or more of the measurements provided by the user, which would allow an accurate matching of influencers with virtually the same body size and shape. This, in turn, results in viewing influencers modeling fashion that would appear virtually the same as the fashion item(s) would appear on the user's searched body size.

Furthermore, while all or most of these exemplary measurements may be requested of the user for their profile, the disclosed platform or service may then be configured to select which measurement(s) are needed to satisfy a match request entered by the user. For example, if the user is employing a platform or service in accordance with the disclosed principles to search for influencers matching the user's pant size in order to shop for pants, then the platform or service would implement the search for matching influencers using only those measurements provided by the user that are related to pant size, such as one or more of hips, waist, inseam, outer seam length, thigh size, and/or calf size. Influencers who have joined the disclosed platform or service would have provided some or all of the same measurements discussed above. The disclosed principles may then match as many of the measurements entered by the influencer, where the more measurements that are the matched, the more likely the influencer matches the user in pant size or whatever the search encapsulates.

Looking briefly at FIG. 3, illustrated is a screenshot 300 on a mobile telephone executing one embodiment of a software application in accordance with the disclosed principles, and providing information to the user on how to take the specific measurement(s) of their body the application has prompted them for. As illustrated, the information provided to the user may be in the form of visual images of where and how a particular measurement should be taken in order to ensure accuracy of the measurement. Alternatively, the information provided to the user may be in the form of a video or multiple videos depicting how to take a particular measurement. Such video(s) may be done using animation or actual video recordings in order to provide demonstration(s) to the user how to properly and accurately take a particular body measurement. In yet other embodiments, the disclosed principles may be configured to be integrated with one or more software applications that can obtain, detect or otherwise determine measurements through reading photographs and/or videos of a user. Such software may employ AI or any other technology that can predict or generate measurements of a user from photographs or video, and the use of any such technology to obtain a user's body measurements is well within the scope of a system or method in accordance with the disclosed principles.

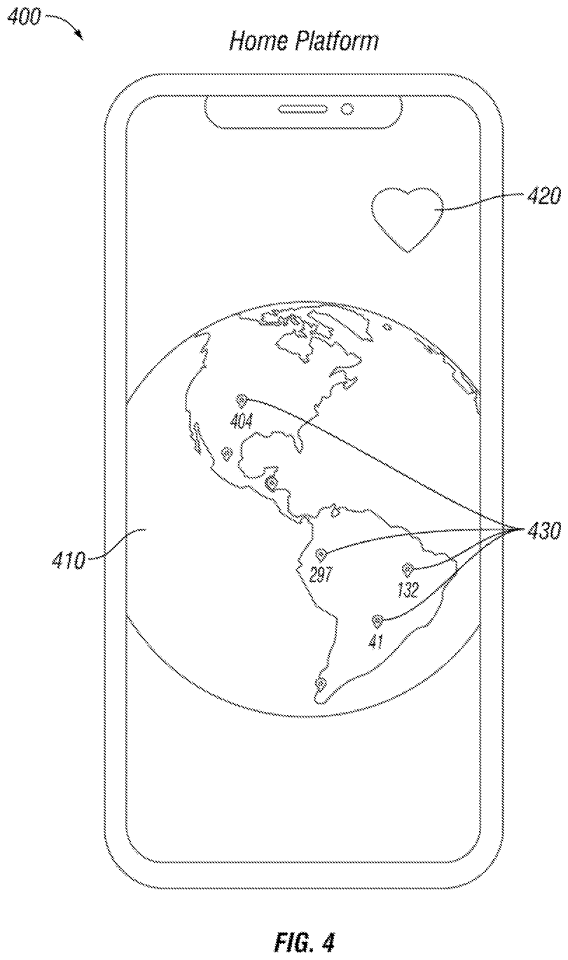

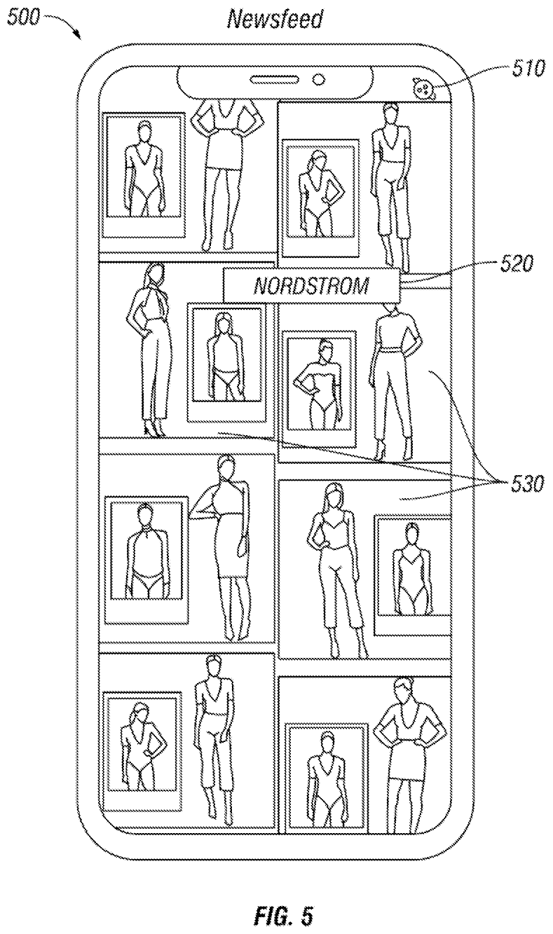

Turning now to FIG. 4, illustrated is a screenshot 400 of a mobile telephone executing one embodiment of a software application in accordance with the disclosed principles, and providing a Home Platform screen 400 to a user. For example, when a new user registers an account with the application, and thus has entered their measurement information, or when an existing user logs back into the application, the user may be presented with the Home Platform screen 400. Alternatively, after the user has provided their measurements, a user then commences a particular search for influencers, and the search results of that search may be provided in a Home Platform screen 400. Users are also able to input their measurements by software designed to assess sizing from photographs or videos.

In the illustrated embodiment, the Home Platform 400 has an interactive globe 410 depicted. Users can toggle the globe around, zoom in and zoom out with their fingers, and otherwise manipulate the depicted globe 410 to see any desired spot on it. In addition, on the illustrated Home Platform screen 400 is a “Favorites” icon 420. This Favorites icon 420, which in this embodiment is depicted in the shape of a heart but in other embodiments may take other shapes or sizes, provides a user a quick link to the user's saved (e.g., “favorited” or “liked” or “tagged”) influencers. In one embodiment, this list of favorite or “liked” influencers may be presented as a scrollable list of influencers. Moreover, this list may be presented to the user in a separate page of the application, or it may be presented as a popup list from the Home Platform 400 from which the user may select an influencer. In some embodiments, the matched influencers from a user's search (discussed in more detail below) may be presented on the globe 410 of the Home Platform 400. In other embodiments, the user's collection of favorite influencers is presented on the interactive globe 410 of the Home Platform 400. In yet other embodiments, a user's list of favorite influencers may instead be provided as the “Newsfeed” of the user, an embodiment of which is discussed in detail below with reference to FIG. 5. In still other embodiments, the Home Platform 400 may include a “List All” button, which would allow the user to simply display a list of all matching influencers based on a search performed by the user. Such a displayed “All” list could also be presented as a Newsfeed page, as discussed below.

Also illustrated on the Home Platform screen 400 are location pins 430 that are populated on the globe 410. These location pins 430 represent influencer geographic locations that have been found by the platform or service of the disclosed principles to match the user's search query or may simply be the collection of saved or “favorited” influencers established by the user. Additionally, the location pins 430 also represented saved (favorited or tagged or liked) brands or retailers of items the user has found when searching for matching fashion influencers. The technique(s) for searching for and determining the matching of influencers is/are discussed below. In embodiments where the location pins 430 represent influencers matching a user's search, the more matches a user has with influencers based on the provided body measurements, the higher number of location pins 430 may be displayed on the globe 410. No matter the embodiment, as the user scrolls around the interactive globe 410, the user can select which location pin 430 they would like to visit. These pins 430 allow the user to globally see where her influencer matches are while providing the additional feature of filtering influencer search results in a number of manners, as discussed further below.

Once the user clicks or otherwise selects one of the location pins 430, the application may then switch to a page or pages specific to the influencer whose location pin 430 was selected. In one embodiment, when a user clicks on a pin, she will be directed to a “Newsfeed” of influencers within that country to browse. FIG. 5 illustrates a screen shot 500 of an exemplary Newsfeed of influencers for a user-selected pin 430. As illustrated, the exemplary Newsfeed may include a “Back” button 510, which when selected would send the user back to the Home Platform screen 400, or another screen that was viewed immediately before accessing the current Newsfeed. Such an exemplary Newsfeed 500 may include advertisement banners 520 as well. These advertisements 520 may be clickable by the user, which would then redirect the user to the advertiser's website or, alternatively, to a page within the application that is sponsored or otherwise dedicated to the advertiser. For example, the advertiser's page could be provided as another Newsfeed, but with only products of the advertiser's displayed or even influencers only modeling products of the advertiser. Turning briefly to FIG. 8, illustrated is a screen shot 800 of an additional embodiment of a Newsfeed, which provides advertisement capability for brands/retailers. In this embodiment, image 810 shows the advertisement for a retailer or brand, and items 820 show images of the fashion advertised tagged to the advertisement by influencers wearing the fashion advertised within a searching user's size demographic. This allows the user to see relevant advertisements by showing how the fashion advertised will look on the user.

Turning back to FIG. 5, the exemplary illustrated Newsfeed 500 may include numerous influencer images 530 as shown in FIG. 5, which may be a display of multiple influencers modeling unique outfits and/or accessories, or may be a display of the same influencer modeling multiple outfits and/or accessories from which the user may select to obtain more information. In one embodiment, an application in accordance with the disclosed principles may provide multiple Newsfeeds. For example, the application may provide a Newsfeed with all of a user's influencer matches, a Newsfeed with influencer matches from a specific country or city selected by the user, and a Newsfeed with a user's “favorite” influencers that they have saved or stored within the application. Of course, other types of Newsfeeds may also be provided, such as a Newsfeed for a particular brand or manufacturer of clothing or accessories, as modeled by their sponsored influencers, or even Newsfeeds for particular styles of clothing/accessories or tagged/liked individual fashion items as well, or any other manner in which clothing, accessories, or other fashion items may be categorized besides by brand.

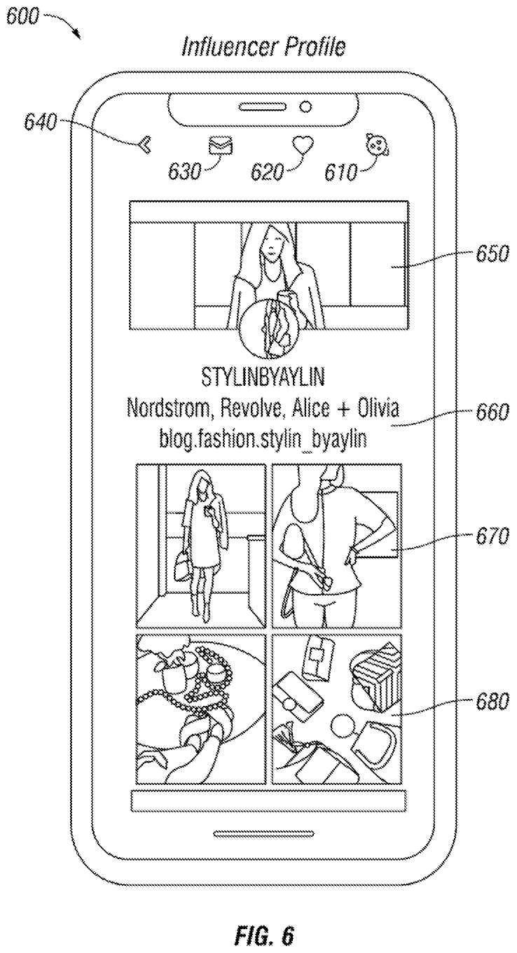

Within a displayed Newsfeed, such as the exemplary Newsfeed 500 depicted in FIG. 5, the images, icons or other displayed items may be “clickable” links so the user would then navigate to a specific page associated with the item/influencer that was selected from the Newsfeed 500. In one embodiment, a particular influencer profile would be displayed based on such a user selection from a Newsfeed 500. FIG. 6 illustrates a screen shot of an exemplary Influencer Profile 600 in accordance with an embodiment of the disclosed principles. As illustrated, the exemplary scrollable Influencer Profile 600 may include a “Home” button 610, which when selected would navigate the user back to the Home Platform 400 discussed above. Alternatively, this button could be a Home button that would navigate the user back to the user's own profile page. In addition, an exemplary Influencer Profile page 600 may include a “Favorites” button 620, which when selected would allow the user to “like” or otherwise save the currently displayed influencer to her favorites list. In addition, another button may be provided to immediately display for the user her complete list of all favorited influencers, and such a “Favorites” page could also be presented a Newsfeed page like the Newsfeed 500 illustrated in FIGURE. 5.

Still further, the exemplary illustrated Influencer Profile page 600 could include a “Messaging” button 630. This button 630 could be configured to allow the user to send the influencer whose Influencer Profile page is being display a direct message. As with many social media platforms, the ability for a user to being able to directly contact a noted person such as an influencer is a desirable feature. Also, an exemplary Influencer Profile page 600 may include a “Back” button 640, which when selected would send the user back to the previous screen the user was viewing before navigating to the particular Influencer Profile 600 they are viewing. This button 640 could be configured to navigate the user immediately back to the Home Platform screen 400, or simply another screen that was viewed by the user immediately before accessing the current Influencer Profile 600.

Within a specific Influencer Profile 600 being displayed, several items may be displayed to the user, of which one or more of these items may be active links to other pages. For example, in the embodiment illustrated in FIG. 6, a profile picture 650 (or video) of the displayed influencer may be displayed. Additionally, influencer information 660 may also be displayed on the Influencer Profile page 600. This influencer information 660 may include any information the influencer chooses to share with users. For example, the information 660 may include personal/biographical information of the influencer, social media platforms the influencer employs, location information of the influencer, or even means for contacting the influencer. Of course, other information related to the influencer, such as brand affiliations, hobbies, etc., may also be displayed in this area.

In addition, an Influencer Profile 600 may include images 670 (or video) of the influencer modeling, for example, various outfits or other clothing. Such images 670 may be categorized by clothing brands/manufacturers, clothing retailers, clothing styles, clothing utility, or any other logical manner of categorization. Other types of fashion items beyond apparel may also be depicts. These images may also be configured as clickable links. In some embodiments, some images 670 may be clicked to navigate the user to retailers or brands sponsoring the influencer or perhaps simply where the influencer shops such that the user may elect to purchase the item in the clicked image. Also, images 670 may be configured such that when a user clicks on a particular image where the influencer is modeling or otherwise displaying a particular clothing item, the price of the item and its size for this influencer may populate, for example, via a popup display. In such an embodiment, when the image 670 is clicked again, the user may be taken to the brand/retailer website where she can purchase the item. As discussed in more detail below, monetization of a platform or service in accordance with the disclosed principles could include the collection of a fee from the brand/retailer for providing such a click-through feature, and perhaps also a fee for each purchase made as a result of such a click-through. In addition, clicking on the item could allow the user to purchase the item directly off the platform, whereby the user will be able to stay on the platform to shop.

Also, the Influencer Profile 600 may include images 680 (or video) of accessories related to the clothing brands, styles, etc. modeled by the influencer. Moreover, these images 680 may show the influencer modeling such accessories or they may be of the accessories alone. As before, the accessories images 680 may be categorized by brands, retailers, styles, what they would be used for (e.g., utility), or any other logical manner of categorizing accessories. Also as before, these accessories images 680 may also be configured to be clickable in the same or similar manner as the clothing images 670 discussed above. For example, clicking an accessories image 680 may cause the popup of additional information about the displayed accessory(ies) such as brand, price, size, available colors or options, etc., and a second click on the image 680 may navigate the user to a webpage where they can view/order one of the accessories.

### Exemplary User Searches

A platform or service in accordance with the disclosed principles employs a software application that matches fashion influencers with consumers via a set of algorithms based initially on physical measurements/dimensions of the influencer and those entered by a user, and then provides possible filtering of search results based on one or more of influencer location, apparel and/or accessory style, brands, particular activities or events to dress for, as well as other personal preferences. By matching fashion influencers with a searching user's provided or obtained body measurements, the consumer is able to utilize influencers as their “virtual self” when shopping for fashion items and thereby eliminating the hassle or problems associated with trying on items before purchase or when ordering items where there is no ability to try them on first. Additionally, the disclosed principles create a social network among users and fashion influencers based on their similarities in not only body size, but also based on fashion styles and even brand and/or retailer preferences.

In accordance with the exemplary screen shots discussed above, a platform or service in accordance with the disclosed principles provides the user the ability to find fashion influencers having the same body size and measurements as those provided by the user. As discussed above, an exemplary search for matching fashion influencers is fundamentally based on body size/measurements. Such size/measurements may include one or more of basic body measurements like chest size, hip size, waist size, but may include additional measurements such as biceps size, thigh size, calf size, neck size, hat size, shoe size, shoulder size, torso length, inseam length, outer seam length, and/or sleeve length. Other measurements, such as simply a conventional dress size, may also be employed. Additionally, as discussed above, software that obtains measurements from photographs or videos may be employed for matching. By providing such specific measurements, as opposed to simply a clothing size, the height, weight, and even gender of the person whose measurements are being collected, the search for fashion influencers is done by matching one or more of the measurements provided by the user, with fashion influencers having substantially the same measurements. As such, the platform or service disclosed herein would also prompt influencers for these same measurements of their respective bodies. Matching the specific body measurements of users allows an accurate matching of influencers with virtually the same body size and shape. This, in turn, results in viewing influencers modeling clothing that would appear virtually the same as the clothing item(s) would appear on the user's searched body size.

Moreover, additional data regarding the actual fashion items that influencers are presenting/modeling may also be collected and stored in an associated database. Such additional data may relate to the type of apparel or accessory (e.g., pants, a shirt, a hat, a necklace, etc.), the style of the piece of apparel or accessory (e.g., casual, chic, classic, grunge, vintage, etc.), the activity or event for which a piece or apparel or accessory is intended for use (e.g., golf, equestrian, prom, wedding, etc.), and even the brands of apparel/accessories or specific retailers where presented apparel or accessories may be purchased. Within a platform or service constructed in accordance with the disclosed principles, once influencers have provided their personal body measurements, this data is stored in influencer profiles in a database associated with the platform or service. Similarly, the body measurements of registered users are also stored in the user profiles, which would also include additional personal information of the users, in an associated database.

Conducting a search by user for matching influencers may be done in any of a number of ways. In one embodiment, a user may, after providing their own body size/measurements to the platform/service, simply search for all fashion influencers that are part of the system that have the same measurements as the user. The search results of matched influencers are then presented to the user, which as discussed above may be in the form of a list of results or may be provided in a visual manner such as the globe 410 illustrated in FIG. 4. Users may also choose to receive notifications when new influencer matches are found, if desired.

As also discussed herein, user searches for matching fashion influencers may also include searching for particular fashion items (i.e., apparel or accessories) as well as other criteria like fashion style, activity, brand, retailer, or any other advantageous search filtering criteria. Alternatively, the user may simply filter the search results of matching influencers based on any such criteria. The specific manner by which a user may enter search information can also vary. In some embodiments, the search for matching influencers is automatic based on the body size/measurements entered by the user. In some embodiments, the user may enter keywords into a search box, such as “pants” or “dresses”, which results in the search for matching influencer being further narrowed to include only those same-size influences modeling or otherwise presenting “pants” or “dresses” as the case may be. Similarly, these criteria may be in the form of search result filters, for example, as checkable boxes among the search results. Search filters are discussed in further detail below.

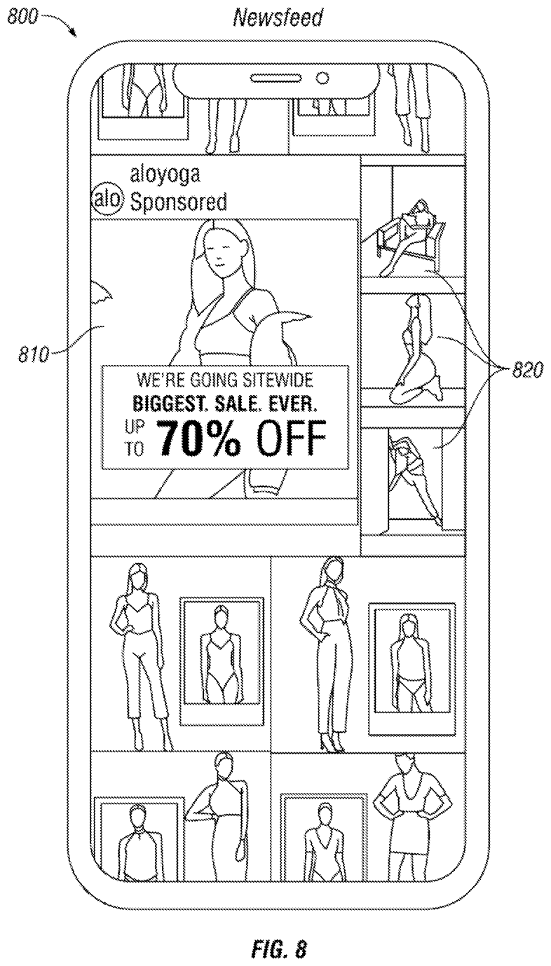

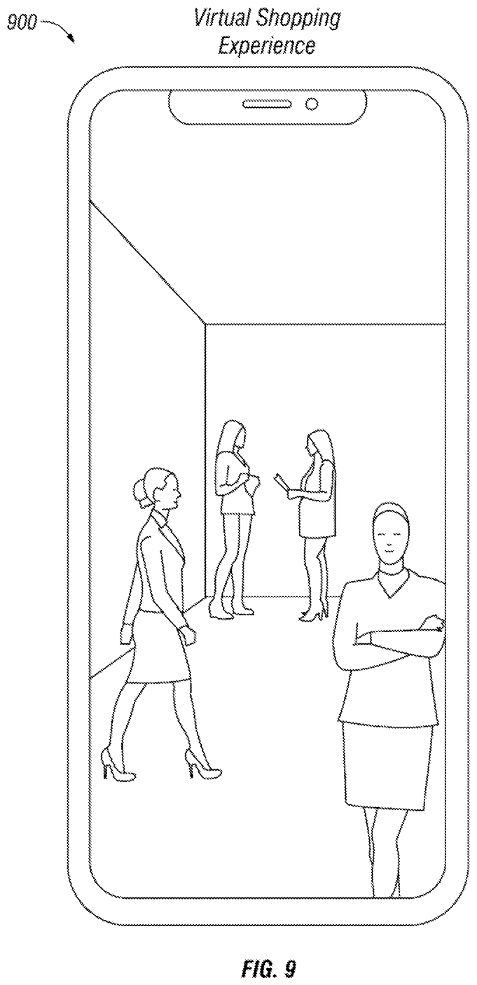

In still other embodiments, a platform or service as disclosed herein may provide for natural language searches based on various “experiences” a user may want to explore. For example, users may create searches such as “I want to go on a hike.” The user may then be shown a virtual background in which matching influencers are embedded and the user can scroll as if they are walking through a forest to different influencers and chose an outfit based on who they most want to look like on the virtual hike. In another example, a user may search for “I want to be in an office.” The user may then be shown a virtual background in which size-matched influencers are embedded in a board room or other office setting, and the user can scroll around the room to see different influencers and chose an outfit based on who they most want to look like in the office setting. For example, looking briefly at FIG. 9, illustrated is a screen shot 900 of one embodiment of a virtual office setting background having size-matched influencers of a searching user. In such embodiments, the user may have filtered their search for size-matched influencers in a manner that indicates that the user is searching for fashion items related to a business office-type setting. As illustrated, a size-matched influencer may be displayed in such office fashion items, which may have additionally been filtered by the user for type, color, or any other filter. Of course, any type of searching and filtering features found in any other type of search engine may also be incorporated into a platform or service as disclosed herein. Such a virtual setting may have the same influencer, or multiple size-matched influencers, populating the virtual setting to present multiple various fashion items to the user. The user may then simply click an influencer or a fashion item on the influencer to obtain additional information and/or navigate to site that allows them to purchase such fashion item(s).

### Search Filters

As users employ a platform or service in accordance with the disclosed principles, such as via an application on a mobile device as illustrated in the preceding figured, users may also be able to filter influencer search results based on any of a number of filters. For example, in some embodiments influencer search results may be filtered by clothing categories, such as swimwear, dresses, jeans, etc., activity or event clothing or accessories may be used for, such as golf, business attire, black tie event, wedding, etc., or perhaps styles of clothing or accessories. In some embodiments, users may filter influencer search results based on specific items, for example, “Mothers ‘Carrie’ Jeans”. The results of a filtered search will produce results within influencer matches, but can also be filtered to produce “all results”, for example, all influencers who have uploaded Mothers “Carrie” Jeans, regardless of size, if desired. Such a filtering feature is useful in those cases where a matching influencer for a particular clothing item was not found by the platform or service, so that the user may still find influencers presenting the sought specific item even if they do not exactly match the same measurements entered by the user. For example, in some situations, an influencer presenting the specific clothing item may match all measurements except the user's provided height, in which case the user may still obtain an excellent view of the item on an influencer who matches the remaining measurements of the user. Of course, other filters may be provided for the user to filter their influencer search results.

### Search Codes

For the matching algorithms of the disclosed principles to search for and match influencers with users, in an exemplary embodiment each of these user and influencer measurement data may be stored as unique code. For example, such a code may be of a preset number of digits, where initial digits could represent identification information, certain digits could represent the type of body measure, while other digits could represent the actual measurement data. As such, codes generated and employed as disclosed herein could be matched by exactly matching digits representing measurement type and size, or only certain code digits may be matched to generate search results. In one embodiment, the search results of matched influencers with a particular user could be ordered such that the greater number of digit matches are displayed first and considered to be the closest matched, and then descending as less digits of influencers' codes are matched.

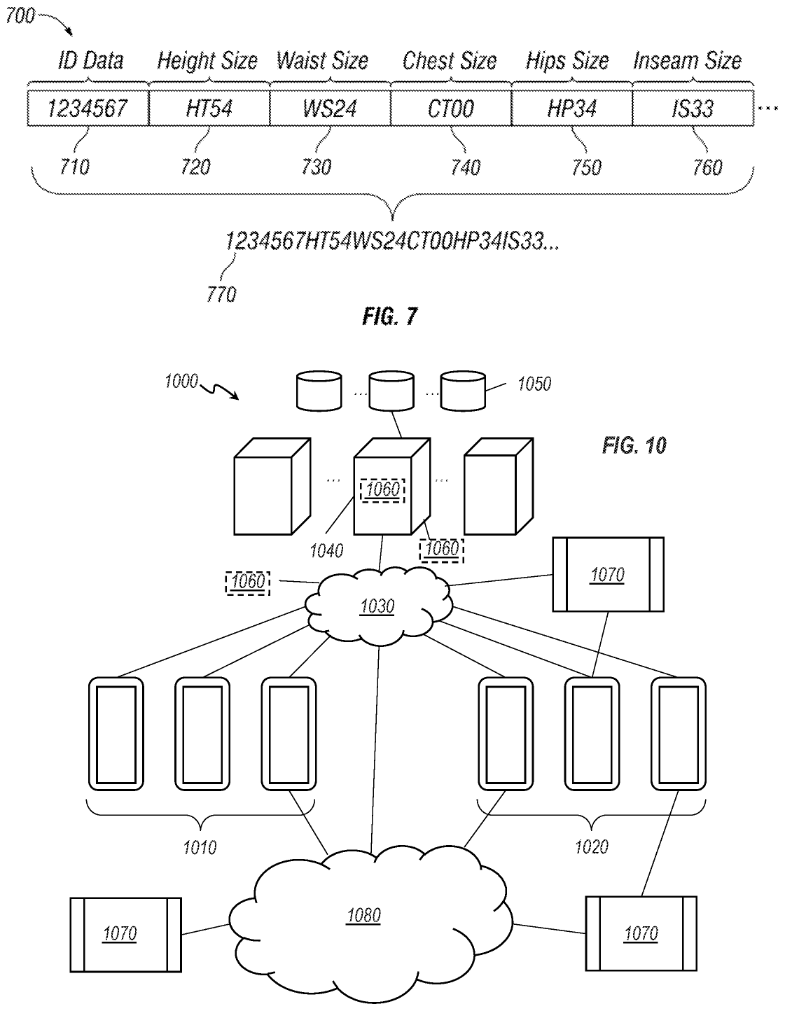

Looking at FIG. 7, illustrated is an exemplary embodiment of a code 700 for use in searching for matching influencers that may be generated by a platform or service in accordance with the disclosed principles. In this exemplary embodiment, the code 700 includes six components, but in other embodiments a code for use as described herein may include any advantageous number of component parts. In this embodiment, the first component of the code is an ID data header 710. This data would be the identification data used to identify the user or influencer associated with this code 700. For example, this could simply by the user or influencer account number, but any type of data digits may be used.

The second component of this exemplary code 700 is the data representing the user or influencer height. This height code 720 may first be represented by the digits “HT” indicating that the next two digits represent the height value. In this embodiment, the height value is “HT54” which would indicate a via the code 700 that the height is 54 inches. Of course, other codes could be configured in other units of measurement, as needed. The next portion of the code 700 is the data representing the user or influencer waist size, which in this embodiment is again in inches. This waist size code 730 may first be represented by the digits “WS” indicating that the next two digits represent the waist size in inches. In this embodiment, the waist size value is “WS24” which would indicate a waist size of 24 inches. The next portion of the code 700 is the data representing the user or influencer chest size, which is again in inches in this embodiment. This chest size code 740 may first be represented by the digits “CT” indicating that the next two digits represent the chest size in inches. In this embodiment, the chest size value is given as “CT00” which would indicate that the user or influencer has not provided their chest size. Thus, any matching of influencers with this code's user would simply not include an attempt to match chest size. The next portion of the code 700 is the data representing the user or influencer hips size, which is again in inches. This hips size code 750 may first be represented by the digits “HP” indicating that the next two digits represent the hips size in inches. In this embodiment, the hips size value is “HP34” which would indicate a hip size of 34 inches. The final portion of the code 700 is the data representing the user or influencer inseam size, which is again in inches. This inseam size code 760 may first be represented by the digits “IS” indicating that the next two digits represent the inseam size in inches. In this embodiment, the inseam size value is “IS33” which would indicate an inseam size of 33 inches. When each of the code portions are viewed together, a code comprising a character string 770 of predetermined length that represents all of a user's or influencer's (or even a brand manufacturer/seller' s) body size measurement information in a single code 770. Of course, a code 700 as used herein may include numerous other components and corresponding digits/values, which may include an actual value or perhaps simply “00” if the user or influencer has not provided that particular measurement. Also, a platform or service as disclosed herein may be configured to work with multiple codes, which may be distinct based on measurement information versus search criteria or category information, such as fashion styles, item type, activity/event use, etc. Of course, such additional information may be simply be appended onto a code 770 as discussed above, as well.

By providing a code such as the exemplary code 700/770 illustrated in FIG. 7 for each user and influencer who joins the disclosed platform or service, the platform or system can search for matching influencers to users by comparing each person's code. As discussed above, the hierarchy of the search results of matching influencers may be presented to the user based on the number of components of the code that are found to match. Specifically which components (i.e., measurements) have been matched (or not matched) may also be displayed to the user so that the user can determine if any particular body measurement they are concerned with have been matched to a particular influencer in the search results or not. Moreover, the same code 700 or even an additional code that may be separate from or appended to the original size code 700 may also be employed to represent other search criteria users may want to use. For example, separate code(s) or code components may be used to codify criteria, such as what particular article of apparel or accessories, the user might be searching for. Similarly, another or an appended code may be used to represent other search criteria, such as the style of apparel/accessories, the activity or event the searched apparel/accessories may be used for, or perhaps the brand or retailer associated with the user's search. Other codes or code components may also be used to represent other criteria a user or influencer may be include in a search.

Importantly, the codes generated or otherwise employed by a platform or service in accordance with the disclosed principles may also be adapted for use with other systems/sites. For example, the same user/influencer codes, whether generated by the disclosed platform/service or an external system, which as discussed above include detailed body size/measurements, may also be employed at manufacturer or retailer sites for easier searching for correctly sized items at the manufacturer or retailer site. Moreover, such uniform code(s) may also be employed by manufacturers or retailers for determining ad impressions for more accurate targeted advertising to users of the disclosed system.

### Multiple Profiles

Users of a platform or service implemented in accordance with the disclosed features may also be capable of establishing multiple profiles for conducting influencer searches. Such a features would be similar to having multiple user profiles on Netflix® or a similar service, where a single account has need for establishing different measurements per profile. In such embodiments, a user may not only establish their measurement for conducting their personal influencer searched but could also establish additional measurement profiles for their children, their spouse, and even friends that may shop for. Similarly, a user may also have multiple profile measurements for themselves, such as a set of body measurements for summer versus winter clothing, and even maternity measurements. Of course, any measurements established on any profile may be revised as needed over time.

### Social Media Features

In addition to searching for and finding matching influencers for themselves, a platform or service implemented in accordance with the disclosed principles may also provide social media features. For example, in some embodiments, users may be able to leave comments on an influencer' s profile page, or perhaps even contact matching influencers directly through the platform/application as discussed above. Also, users may be able to “like” items and even “share” items or influencers with other users via messaging or other services available through the platform/application. Direct messaging with other users, or perhaps only “friended” users, may also be provide. Moreover, some embodiments may allow users to make their own profile publicly viewable. In such embodiments, other users may “follow” or otherwise view a user's activity on the platform or application, and perhaps even comment on the user's likes, searches, favorites, or other activity. Also, with such a public presence, users may even be capable of uploading their own modeled clothing or accessories for their “friended” users or even all users, thereby becoming somewhat of a social influencer themselves.

### Influencer Features

Separate from the user's access and use of a platform or service implemented in accordance with the disclosed principles is the access and use of the platform or service by the influencers themselves. Influencers may be provided with a different version of an application for their computer or mobile computing device which provides additional features not needed by users. For example, in addition to influencers providing their own body measurements, sizes, and other information, influencers would also be capable of providing their favorite brands or official brand affiliations, as well as images/vides of their presenting/modeling of such brands. Influencers may also be able to provide additional information useful for searches, such as particular styles they prefer, particular clothing or accessories they focus on, or even particular colors, events, activities, etc. related to the clothing or accessories they present on their influencer profile. Influencers may also be given the ability to allow or turn off comments from users on their profile page, and may even be able to block certain users should the need arise based on a user's activity towards the influencer. Moreover, influencers would be capable of providing links to find/buy specific items they present, which would allow influencers to further monetize their presentations of their brand affiliations.

### Brand Advertisement and Influencer Matching

In addition to the features and users discussed above, clothing brands/retailers may also be able to advertise on the platform. Such advertisements may populate into users' Newsfeeds based on the criteria the brand enters (size specific, country specific, styles, categories, etc.). Also, influencers may be able to “tag” brand advertisements, so users seeing an advertisement can also see the advertised clothing on a person of their matched size via the tagged influencer' s photos and/or videos (see, e.g., FIG. 8.) A platform or service as disclosed herein may also provide a matching process beyond consumers with influencers. In such embodiments, a paid affiliate program may be provided to the member influencers and brands/retailers. Such a program employs the same novel technology behind the user-influencer size matching process so that brands/retailers can search for and match with influencers or influencers can match with brands/retailers. For example, influencers may search for and match with brands based on their body size, style, events or activities, etc. compared to the brand's target size demographic, style of clothing offered, etc. in such embodiments, the result is a pool of brands/retailers for a particular member-influencer to try to affiliate with, as well as a pool of influencers for the brand/retailer to determine if they would like to affiliate with. Once matched, brand manufacturers or retailers may then also create advertisements for display on any page of an application as disclosed herein, which influencers may then tag, and user's can be shown a tagged influencer or size-matched influencer wearing the advertised item. In such embodiments, instead of the user browsing through a series of size-matched influencers, the user simply sees an advertisement for an item that they would like to see how it would fit them, and then by simply clicking the advertisement the user's measurement information is used to display an influencer having the user's match measurements and wearing the advertised item (see, e.g., FIG. 8.)

### Monetization

Systems, platforms or services constructed and implemented in accordance with the disclosed principles provide a number of ways for monetization. Revenue may be generated through paid advertisements from brands and retailers of fashion, which may be displayed on any of the various screens presented to users and/or influencers. As another means of generating revenue, fees may be collected based on click-throughs by users, such as on specific fashion items presented or posted by matched influencers that the user chooses to click on. Such a link may send the consumer directly to the website of the brand for purchase. Alternatively, a platform or service as disclosed herein may be configured such that influencers themselves may sell items directly to user, whether those items are manufactured by the influencer themselves or are simply promoted by the influencer. Alternatively, users will be able to purchase fashion directly off the platform, without being sent to the fashion brand/retailer website. When a user adds an item to their shopping cart, or clicks to purchase, the item will automatically populate in the user's correct size based on their body measurements entered.

Also, a premium version of the disclosed platform or service may be provided, which for a periodic fee can remove the presentation of some or all of the advertisements to users. However, monetization may still be possible via other means, such as click-throughs by users on particular influencers or even particular images/videos of influencers presenting a specific brand item or item(s) from a particular retailer. An influencer-based premium (paid) version may also be employed, which may provide such influencers with advantages such as more prominent visibility among search results, permitting influencers to search for users, or other advantageous features. Such a premium version may also be the version of a platform or services that permits influencers to sell items directly to user, as discussed above.

Furthermore, value in the disclosed platform or service may be built by placing brands directly in front of their target demographic. In addition to brands or retailers posting an advertisement, influencers affiliated with a particular brand or retailer would be able to tag the advertisement. This would allow a consumer to see clothing items within ads on an influencer' s profile or Newsfeed, which are in the user's size, further progressing the connection between consumer and influencer as well as consumer and brand. Promoting connections between brands and influencers is also possible with the disclosed principles. For example, if a brand affiliated with “plus size” clothing is looking for plus size influencers to represent their clothing line, a platform or system as disclosed herein would be capable of providing a separate collection, perhaps in a separate database, of plus size influencers to that brand to match with. Appropriate personnel within the brand company may then view and select influencers they feel would best represent and promote their brand. For the plus size influencer, the converse is also possible, with a separate collection or database of plus size brands for influencers seeking new brands to represent to match with. From such a filtered collection of searched potential brands for the influencer, the influencer can browse and further filter brands (e.g., by styles, items, activities/events, country of manufacture, etc.) that align with her audience. Likewise, the brand can filter influencers that align with the culture, style, etc. of the company. Of course, any type of monetization strategy, either now existing or later developed, may be integrated into a platform or service constructed and implemented in accordance with the principles disclosed herein.

### Exemplary Platform

Turning now to FIG. 10, illustrated is one embodiment of an exemplary platform or system 1000 constructed and implemented in accordance with the disclosed principles. Initially illustrated in FIG. 10 is a plurality of fashion consumer devices 1010 executing a corresponding plurality of applications as discussed above. Although the collection of fashion consumer devices 1010 are illustrated in this embodiment as mobile telephones, it is understood that one or more of the devices 1010 may also be implemented as tablets, desktop computers, or any other type of computing device capable of executing software applications as disclosed herein and to interconnect to one or more communications networks. As discussed in detail herein, the consumer devices 1010 are operated by corresponding fashion consumers in the manner and for the purposes as disclosed herein.

Also illustrated in FIG. 10 is a plurality of fashion influencer devices 1020. As with the consumer devices 1010, the fashion influencer devices 1020 are capable of executing a corresponding plurality of influencer applications as discussed above. Also as with the consumer devices 1010, the fashion influencer devices 1020 may also be implemented as mobile telephones, tablets, desktop computers, or any other type of computing device capable of executing software applications as disclosed herein and of interconnecting to one or more communications networks. Also illustrated in FIG. 10 is a platform communications network 1030. The network 1030 may be implemented as a dedicated private communications network, or may comprise a public communications network. In addition, the network 1030 over which the disclosed platform 1000 is implemented may be any type of communications network, such as a data packet network, a packet-switched network, a part of the publicly-accessed Internet, or any other type of computer or communications network whether wired, wireless or both. As illustrated, the fashion consumer devices 1010 and the fashion influencer devices 1020 are connected to and communicate across the platform network 1030 using any type of communications protocol either now existing or later developed, and such communication is facilitated via the corresponding plurality of applications implemented in accordance with the disclosed principles.

Also connected to the platform network 1030 and comprising a part of the disclosed platform 1000 is a computer server 1040. As illustrated, the server 1040 may be implemented as a single server or may be implemented as a collection of multiple servers, as needed. Each such server 1040 comprises both hardware, firmware and software, as well as a communications interface, for communicating and implementing the disclosed principles across the platform network 1030 and with one or more of the fashion consumer devices 1010 and fashion influencer devices 1020. In communication with the one or more servers 1040 are one or more storage databases 1050. Such databases 1050 are comprised of both hardware, firmware and software, and configured for creating, storing and accessing data files and folders, including the fashion consumer and fashion influencer profiles disclosed herein.

Within the platform 1000 hardware, such as one or more of the servers 1040 or in one or more computing devices, or other hardware in communication with the servers and/or the databases 1050 and network 1030, is a computer processor or multiple processors 1060. Such processor(s) 1060 comprises hardware for executing software and/or firmware for implementing the principles disclosed herein. As shown, such processor(s) 1060 may be included within a server 1040, of maybe be comprised in a separate computing component in communication with the server 1040 either directly through a wired or wireless interface, or in communication via the platform network 1030. Of course, other architectures for providing the one or more processors 1060 may be implemented with a platform as disclosed herein. Moreover, the processor(s) 1060 is a specialized computing component having hardware, firmware and software, as required, for implementing a platform 1000 or related service in accordance with the principles disclosed herein. Included among these implemented principles is the facilitating of communication with the applications executed on the fashion consumer and fashion influencer devices 1010, 1020 for not only creating and causing the storage of consumer and influencer profiles in the databases 1050, but also for providing the matching of influencers to consumers as described in detail herein.

Such matching of fashion influencers to fashion consumers by capturing specific body measurements of both parties by the processor(s) and interconnected hardware and software of the disclosed platform 1000, and then matching those body measurements among consumers and influencers to ensure a proper fit for fashion items, provides a novel solution to a problem that arises in computer-based (e.g., online) environments. Specifically, when a fashion consumer browses and shops for fashion items online, the computer-based environment of online shopping creates the problem of how the consumer can be certain that a fashion item fits their particular body size/measurements. In the traditional brick-and-motor shopping environment, the consumer would simply try on the fashion item to ensure a proper fit. But such trying on is not possible in the online shopping realm. The solution of simply ordering fashion items for trying on at home and then returning those that do not fit is not a solution to this computer-based conundrum since not only is such shipping and returning of items costly, time-consuming and tedious, but such a solution simply converts the online shopping experience to an in-person try-on experience. Even an online shopper trying to “eyeball” a fashion influencer or model online in an effort to determine if a particular fashion item would fit them based on how it fits the influencer/model does not provide a viable solution to the computer-based problem since doing so does not provide any certainty to the results of such a guessed fit. Instead, the disclosed principles provide a novel computer-based solution to a problem that is necessarily rooted in the computing environment of online shopping by searching for and matching fashion influencers that have been mathematically determined to have the same (or very similar) body measurements as the fashion consumer shopping online.

Also illustrated in FIG. 10 is a plurality of manufacturer and/or retailer webpages 1070 associated with fashion brands and/or fashion influencers accessible via a platform 1000 in accordance with the disclosed principles. As shown, some such webpages 1070 may be in communication with one or more of the platform 1000 components (either illustrated or not) via the platform network 1030. Such manufacturer/retailer webpages 1070 may be interconnected with the fashion influencers 1020, either directly, through the platform network 1030 or via a public communications network 1080, to provide one or more of the features of online shopping discussed herein. For example, a fashion consumer, once finding a matching fashion influencer, may then browse that influencer' s social media or other type of webpage looking for fashion items. By selecting a found fashion item via such influencer page or site, the platform 1000 may facilitate the purchase of that fashion item by the fashion consumer, and this may be facilitated by navigating the consumer to the webpage 1070 of the manufacturer or retailer of that item. Alternatively, as also disclosed herein, the matched influencer may have an affiliation with a particular manufacturer or retailer such that the matched influencer's application or page within the platform 1000 provides directly selling that fashion item. As discussed above, monetization via the platform 1000 is possible in each of these scenarios through hosting advertisements on the influencer's page or site, as well as percentages of sales of fashion items via the influencer' s page or site or click-through monetization for influencers when consumers are navigated to a manufacturer's or retailer's site from the influencers' pages or sites.

Also as illustrated in FIG. 10, a platform 1000 as disclosed herein may also include or be in communication with a publicly available communications network 1080, which may be the Internet or other similar network. As shown, when a disclosed platform 1000 is in communication with such a public communications network 1080, some or all of the platform components, such as the fashion consumer devices 1010, fashion influencers, and retailer/manufacturer webpages 1070, may communicate via the public network 1080. In other embodiments, a platform as disclosed herein may use only a public network, such as the Internet, for implementing the disclosed principles, or may include more than two communications networks interspersed between or among components of the platform. No limitation to any particular number or type of communications networks or any particular number or type of components for implementing a platform and service as disclosed herein is intended or should be inferred.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

1. A platform interconnecting fashion consumers and fashion influencers, the platform comprising:
a plurality of stored fashion influencer profiles, each profile associated with a corresponding fashion influencer and including body measurements of the corresponding fashion influencer;
a plurality of stored fashion consumer profiles, each profile associated with a corresponding fashion consumer and including body measurements of the corresponding fashion consumer;
a database storing said fashion influencer profiles and said fashion consumer profiles;
a plurality of software applications executable on a corresponding plurality of fashion consumer devices, each of said plurality of software applications in communication with said platform via a communications network to provide said body measurements of each corresponding fashion consumer via device input by each corresponding fashion consumer input; and
a processor in communication with the database and the plurality of software applications, the processor executing software configured to:
receive, from a searching fashion consumer via one of the plurality of software applications, a search query comprising description of a fashion item originally presented by the searching fashion consumer to find fashion influencers modeling the described fashion item;
in response to receiving the search query from the searching fashion consumer, identify body measurements from the stored profile of the searching fashion consumer;
in response to identifying the body measurements of the searching fashion consumer, compare the identified body measurements of the searching fashion consumer to body measurements in the stored profiles of said fashion influencers;
in response to the receiving of the search query and to the comparing, identify fashion influencers modeling the selected fashion item originally presented by the searching fashion consumer via the search query, and having one or more stored body measurements matching corresponding one or more stored body measurements of the searching fashion consumer;
in response to the identifying matching fashion influencers, present said identified matching fashion influencers to the searching fashion consumer via the one of the plurality of software applications; and
after the presenting of the identified matching fashion influencers, facilitate communication from the searching fashion consumer to one or more of the identified matching fashion influencers via the one of the plurality of software applications.

2. The platform of claim 1, wherein the received search query further comprises a search for a particular clothing item originally presented by the searching fashion consumer without prompting or suggestion by the platform, and wherein the processor is further configured to identify fashion influencers having all of the stored body measurements pertaining to the particular clothing item and matching the corresponding body measurements of the searching fashion consumer.

3. The platform of claim 1, wherein the received search query further comprises a search for particular ones of the one or more stored measurements selected by the searching fashion consumer, and wherein the processor is further configured to identify fashion influencers having all of the stored particular ones of the body measurements matching the corresponding selected particular ones of the body measurements of the searching fashion consumer.

4. The platform of claim 1, wherein the facilitated communication between the searching fashion consumer and one or more of the identified matching fashion influencers comprises facilitating interaction with a social media page hosted on the platform of an identified matched fashion influencer and the searching fashion consumer via their software application and device.

5. The platform of claim 4, wherein the social media page of the identified matched fashion influencer comprises one or more presentations of the identified matched fashion influencer modeling one or more fashion items.

6. The platform of claim 5, wherein the facilitating interaction comprises facilitating shopping, by the searching fashion consumer, for one or more modeled fashion items via the one or more presentations on the social media page of the identified matched fashion influencer.

7. The platform of claim 6, wherein the facilitating shopping comprises navigating the searching fashion consumer to a webpage of a manufacturer or retailer associated with a modeled fashion item selected by the searching fashion consumer, using their application, from the social media page of the identified matched fashion influencer.

8. The platform of claim 4, wherein the facilitating interaction comprises presenting advertisements to the searching fashion consumer via the social media page of the identified matched fashion influencer.

9. The platform of claim 5, wherein the facilitating interaction comprises facilitating direct communication by the searching fashion consumer with the identified matched fashion influencer.

10. The platform of claim 1, wherein the processor further converts said stored body measurements of said fashion consumers and said fashion influencers into a code string comprising a code for each body measurement, and wherein the processor identifies fashion influencers having one or more body measurements matching corresponding one or more body measurements of the searching fashion consumer by comparing said code string for the searching fashion consumer with the code string for each fashion influencer.

11. The platform of claim 10, wherein each code of a code string comprises a data header identifying a particular type of body measurement and a data field containing actual measurement data corresponding to each data header.

12. The platform of claim 1, wherein said plurality of software applications further provide filtering of said search query or said presented identified matching fashion influencers based on one or more of matching fashion influencer geographic location, fashion item, fashion brand, fashion style, fashion consumer's selected style, fashion for a particular activity, or fashion for a particular event.

13. The platform of claim 1, wherein said plurality of software applications further provide for saving, by fashion consumers, a list of favorites of identified matching fashion influencers by fashion consumers.

14. The platform of claim 1, wherein said plurality of software applications further provide for saving, by fashion consumers, a list of favorites of fashion items found by a searching fashion consumer and affiliated with identified matching fashion influencers.

15. The platform of claim 1, wherein the processor further presents geographic locations of each of said identified matching fashion influencers to the searching fashion consumer via the one of the plurality of software applications;

16. The platform of claim 15, wherein the one of the plurality of software applications presents the geographic locations via an interactive visual depiction of a globe having visual icons identifying the geographic locations on the globe.

17. The platform of claim 16, wherein the visual icons are interactive, wherein interaction with a visual icon by the searching fashion consumer causes presenting of information related to the matching fashion influencer corresponding to the interacted visual icon.

18. The platform of claim 1, wherein body measurements of each said corresponding fashion consumer comprise one or more measurements selected from the group consisting of: chest size, hips size, waist size, biceps size, thigh size, calf size, shoe size, neck size, hat size, shoulder size, torso length, inseam length, outer seam length, and sleeve length.

19. The platform of claim 1, wherein the plurality of software applications assists fashion consumers with providing the one or more body measurements using one or more selected from the group of: one or more animations depicting how to take a particular measurement, one or more images depicting how to take a particular measurement, one or more videos depicting how to take a particular measurement, or software capable of determining a particular measurement from an image or video.

20. The platform of claim 1, further comprising another plurality of software applications executable on a corresponding plurality of fashion influencer devices, each said software application in communication with said platform via the communications network to provide said body measurements of the corresponding fashion influencer via fashion influencer input via their devices.
